(19) United States
(12) Patent Application Publication
(10) Pub. No.: US 2005/0265132 A1
(43) Pub. Date: Dec. 1, 2005

(54) Connection structure for a watchcase with a watch chain

(76) Inventor: Kai Cheung Ho, Kowloon (HK)

Correspondence Address: J.C. Patents;Suite 250, 4 Venture, Irvine, CA, 92618, US

(21) Appl. No.: 11/088,608

(22) Filed: Mar. 23, 2005

(30) Foreign Application Priority Data
May 28, 2004 (CN) 2004200592519

(51) Int. Cl. G04B 37/00

(52) U.S. Cl. 368/282

(57) ABSTRACT

A connection structure for a watchcase and a watch chain comprises a through groove on each side of the watchcase longitudinally, a through hole vertical to a side edge of the groove, a flange disposed on each side of the watch chain and engaged with the groove for connecting with the watchcase, a slot in the flange at a position corresponding to the through hole, in which a locking device is provided. The watchcase can be attached with and detached from the watch chain quickly through the connection structure without any special tool.

### CROSS-REFERENCE TO RELATED APPLICATION

This application claims the priority benefit of Chinese Utility Model Application No. 2004200592519 filed on May 28, 2004, the content of which is hereby incorporated in its entirety herein by reference.

### FIELD OF THE INVENTION

The present invention relates to a connection structure for a watch, particularly to a structure connecting a watchcase with a watch chain.

### BACKGROUND OF THE INVENTION

At present, watches are widely used in our ordinary lives. A watch is becoming a necessary ornament rather than a timepiece. No one content to wear one watch during his whole life. For most people, they want to change the watch chain at will. However, the watchcase is commonly connected with the watch chain by connection bars. In such conventional construction, two pairs of lugs are disposed on both sides of the watchcase, each pair having a pair of cylindrical cavities or holes therein accommodating two ends of the bar. The connection bar may be a spring pin, comprising a cylindrical tube containing a compression spring, and two cylindrical mandrels disposed in the tube and spaced by the spring. The mandrels are inserted into the cavities or holes in the lugs to connect the watchcase with the watch chain. However, the detaching operation for the watchcase and the watch chain must be performed with the aid of special tools, which may bring inconvenience to the user. No one wants to often go to a watch shop for replacing the watch chain every time. If the user replaces it with own tools, unsuitable tools may risk damaging the connection structure of the watchcase and watch chain, or untight attachment between them, which may lead to detachment and losing the watch. The pin is inserted between the lugs by pushing the mandrels into the tube when being used to connect the watch chain with the watchcase. Then, the mandrels are urged into the cavities or holes when they are registered with each other. But the mandrels cannot be fixed in the axis direction. Therefore, the conventional connection structure does not meet the requirement.

### SUMMARY OF THE INVENTION

The present invention relates to a connection structure for a watch, through which the watchcase can be connected with the watch chain quickly and tightly without any special tool.

To achieve the above object, the present invention provides a connection structure for a watchcase and a watch chain, comprising a through groove on each side of the watchcase longitudinally, a through hole vertical to a side edge of the groove, a flange disposed on each side of the watch chain and engaged with the groove for connecting with the watchcase, a slot in the flange at a position corresponding to the through hole, in which a locking device is provided.

The groove may have a half-circular section, the width between two side edges of which is smaller than the diameter of the circle, and the shape of the flange of the watch chain matches with that of the groove.

The groove may have a wedged section, and the shape of the flange of the watch chain matches with that of the groove.

The groove may have a T-shaped section, and the shape of the flange of the watch chain matches with that of the groove.

The through hole may be cylindrical or prismatic, and the shape of the slot of the flange matches with that of the through hole.

The locking device may comprise a catapult nail in the through hole and an elastic element in the slot.

The advantage of the present invention is obvious. The watchcase can be attached with and detached from the watch chain quickly through the connection structure without any special tool. It brings more convenience to the user.

### BRIEF DESCRIPTION OF THE DRAWING

FIG. 1 includes an illustration view and a partial section view of the connection structure according to an embodiment of the present invention;

FIG. 2 is a view illustrating the connection structure according to an embodiment of the present invention in a detachment condition;

FIG. 3 is a view illustrating the connection structure according to an embodiment of the present invention in an attachment condition;

FIG. 4 is a view illustrating the connection structure according to another embodiment of the present invention;

FIG. 5 is a view illustrating the connection structure according to a further embodiment of the present invention;

### DETAILED DESCRIPTION OF THE PREFERRED EMBODIMENT

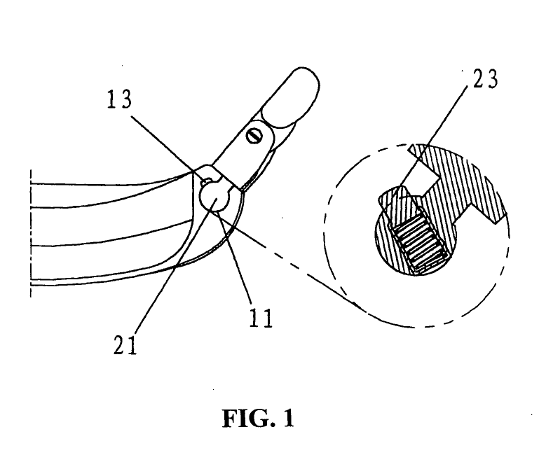

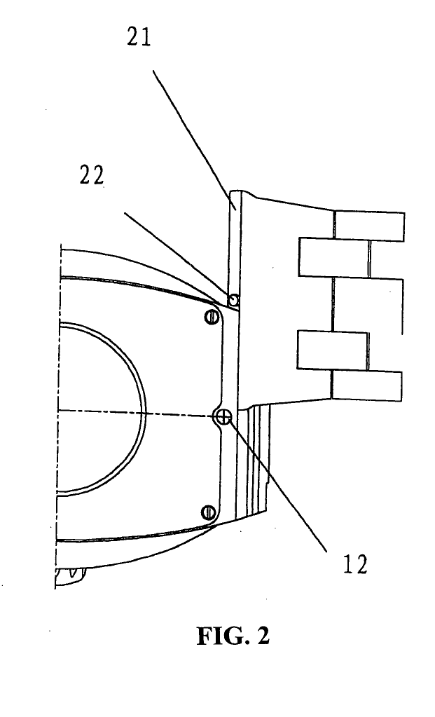

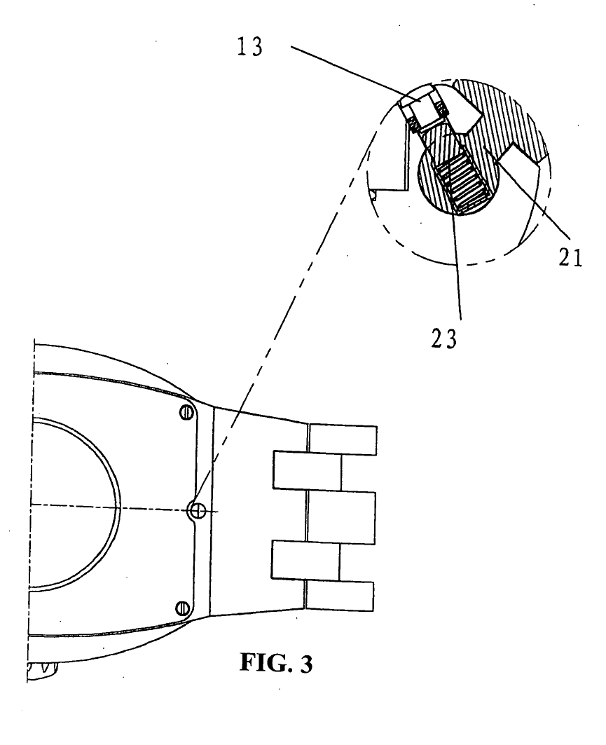

The present invention relates to a connection structure for a watchcase and a watch chain, as shown in FIGS. 1, 2 and 3. The watchcase comprises a through groove 11 on each side longitudinally and a through hole 12 vertical to a side edge of the groove 11. The watch chain comprise a flange 21 on each side engaging with the groove 11 for connecting with the watchcase, a slot 22 in the flange 21 at a position corresponding to the through hole 12, in which a locking device is provided. The locking device comprises a catapult nail 13 in the through hole 12 and an elastic element 23 in the slot 22. The watch chain and the watchcase are connected with each other by the above-mentioned connection system.

In an embodiment shown in FIGS. 1, 2 and 3, the section of the groove 12 has a half circular shape, the width between two side edges of which is smaller than the diameter of the circle. The shape of the flange of the watch chain matches with that of the groove. In use, the flange of the watch chain is inserted into the groove longitudinally and slides along it till the elastic element 23 of the watch chain is stopped and contacts against the catapult nail 13 to form a locking system. The elastic element 23 may be a spring. Any conventional construction may be used to form the elastic element 23 and the catapult nail 13 or any conventional structure performing the same function could be employed to replace such locking device. When the user replaces the chain, instead of special tools, any article with a tip, such as a ball pen, may be used to push the catapult nail 13 in the through hole 12 to urge the elastic element 13 to a compressed state. Then, the flange 21 could be pulled out and the detachment is completed. For assembling the watch chain and the watchcase, the flange 21 of the watch chain is inserted into the groove directly in a longitudinal direction and slides along it till the elastic element 23 contacts with the catapult nail 13 under the resilience force to fasten the watchcase and the watch chain together. Then, the tight attachment of the watch chain and the watchcase is completed.

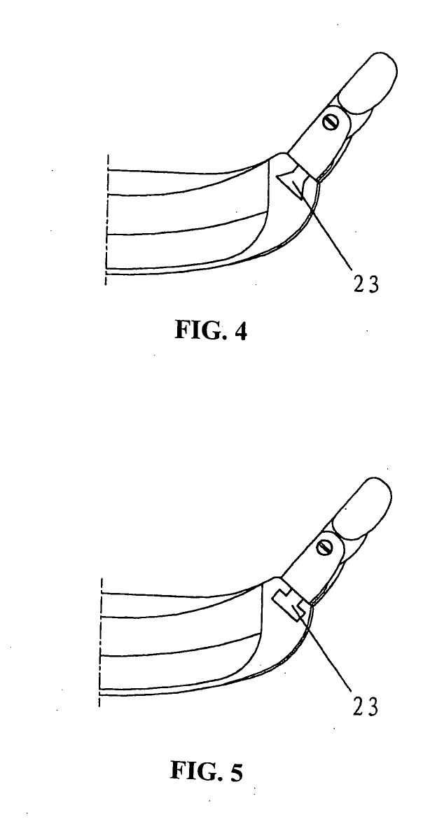

As shown in FIGS. 4 and 5, the groove 11 has a wedged or T-shaped section. The shape of the flange 21 of the watch chain matches with that of the groove 11. Other parts of the connection structure are same as those of the above-mentioned structure and the description is omitted.

The through hole 12 of the groove 11 of the present invention may be disposed in the inner side or the outer side of the watchcase. The through hole 12 may be cylindrical or prismatic for matching with catapult nails with different shapes or other similar locking component. The slot 22 of the flange 21 and the elastic element 23 respectively have a shape corresponding to the through hole 12.

Through the above-mentioned connection structure of the present invention, the watchcase and the watch chain are connected tightly and can be detached easily.

1. A connection structure for a watchcase and a watch chain, characterized in that it comprises a through groove on each side of the watchcase longitudinally, a through hole vertical to a side edge of the groove, a flange disposed on each side of the watch chain and engaged with the groove for connecting with the watchcase, a slot in the flange at a position corresponding to the through hole, in which a locking device is provided.

2. A connection structure for a watchcase and a watch chain as claimed in claim 1, characterized in that the groove has a half-circular section, the width between two side edges of which is smaller than the diameter of the circle, and the shape of the flange of the watch chain matches with that of the groove.

3. A connection structure for a watchcase and a watch chain as claimed in claim 1, characterized in that the groove has a wedged section, and the shape of the flange of the watch chain matches with that of the groove.

4. A connection structure for a watchcase and a watch chain as claimed in claim 1, characterized in that the groove has a T-shaped section, and the shape of the flange of the watch chain matches with that of the groove.

5. A connection structure for a watchcase and a watch chain as claimed in claim 1, characterized in that the through hole is cylindrical or prismatic, and the shape of the slot of the flange matches with that of the through hole.

6. A connection structure for a watchcase and a watch chain as claimed in claim 1, characterized in that the locking device comprises a catapult nail in the through hole and an elastic element in the slot.
